(19) United States
(12) Patent Application Publication
(10) Pub. No.: US 2016/0255950 A1
(43) Pub. Date: Sep. 8, 2016

(54) ERGONOMIC DESK AND MODULAR DESIGN FOR COLLABORATIVE DISPOSITIONS

(71) Applicants: David Mata Valdes, Madrid (ES); Carlos Riquelme Ruiz, Madrid (ES)

(72) Inventors: David Mata Valdes, Madrid (ES); Carlos Riquelme Ruiz, Madrid (ES)

(21) Appl. No.: 14/636,218

(22) Filed: Mar. 3, 2015

(51) Int. Cl. A47B 21/02; A47B 13/08; G06F 1/16; A47B 9/10; A47B 9/20; A47B 13/10; A47B 21/04

(52) U.S. Cl. CPC A47B 21/02; A47B 13/10; A47B 13/088; A47B 21/04; A47B 9/10; A47B 9/20; G06F 1/16

(57) ABSTRACT

Ergonomic desk and modular design for collaborative dispositions, where said ergonomic desk has an upper desktop (1) of trapezoid shape, with an ergonomic curve adapted to the user, a height-adjustable plane (2) in an angle in the middle of said desktop raised by a telescopic linear actuator, a footrest tray (3), a raised tray (6) and motor-driven height-adjustable legs (9) moored to a flat support (8) with wheels (10) and an electronic device with a touch-screen (5) to operate the assembly, characterised by the fact that with a modular coupling of six ergonomic desks, creating a hexagonal unit, a working area of 7.8 m2 is obtained, within a 9.9 m2 square, representing a 38% reduction of the working area created with traditional desks.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Technical Field

The field of the invention is that of the industry for the manufacture of ergonomic office furnishings and, more specifically, of ergonomic (height-adjustable) office desks.

The invention is also related to the industry that manufactures electronic devices adapted to specific functions.

2. Description of the Related Art

There are some antecedents referring to ergonomic working devices, and more particularly to work desks.

The inventor is aware of the existence of various patents:
EP 0 917 840 A2. This patent consists essentially of an office desk with two tops which can be raised to different working heights: one in front for the user and the other behind for the monitor.
There are in fact substantial differences from the invention proposed, which can be summarised as follows:
   a) the division of the work areas follows different criteria.
   b) problems or disadvantages of the EP referred to:
   b.1.—The design of the working surface is not optimised for maximum user benefit.
   b.2.—The tops can be raised, but none inclines so that they are unable to adapt fully to any working posture.
   b.3.—All handling is manual, aided by electric motors, and there is no electronic backup or control making it possible to store use guidelines or postures.
WO2004008911A2 (BRETFORD MFG INC) disclosing a modular system of individual desks which can be coupled in many ways, and with an ergonomic desktop housing the monitor and the outstretched legs, the working area adequate for the user's reach without having to move the chair, and just extending the arms. Unlike the base document, it does not reveal that the central part of the desktop has a lifting mechanism and, moreover, the main base is specifically to carry a monitor.
U.S. Pat. No. 6,220,181B1 (HORSKI MAREK) discloses an ergonomic computer table with a working area adequate for the user's reach without having to move the chair, and just extending the arms, with a desktop divided into two parts, one for the computer and the other with a lifting mechanism to adapt it to different work postures.
This is actually different in significant ways from the invention proposed, for the following reasons:
This is a computer table;
The desktop is divided into two parts always,
The rotating part turns upon itself and cannot be directly raised above the table, so that there is no straight support for the hands,
It does not have movable armrests,
It cannot be adapted ergonomically to others of the same type
U.S. Pat. No. 5,174,223A (NAGY MARTA K; FORIS VICTOR G) shows a height-adjustable ergonomic table with an inclining desktop centre and a movable footrest tray. Of the multiple differences with the invention proposed it is seen that this a table to house a monitor, the footrest tray can only be moved but not articulated, the working area is not ergonomically adapted and the mobile surface turns on itself so that the rear hand support is zero.

### BRIEF SUMMARY OF THE INVENTION

The invention referred to in these specifications is an ERGONOMIC DESK AND MODULAR DESIGN FOR COLLABORATIVE DISPOSITIONS of the type comprising a height-adjustable desktop divided into three zones at various levels, where the working surface of the desktop is adaptable, ergonomic and optimised for working with portable devices. Thanks to its modular design, it can also be combined advantageously with other identical desks for collaborative work, ergonomically and with optimal use of office space in its relation to the available working area.

### BRIEF DESCRIPTION OF THE DRAWINGS

For a better understanding of the invention, five pages of plans are attached, showing the following views.

FIG. 1.: Overhead view of the ergonomic desk.

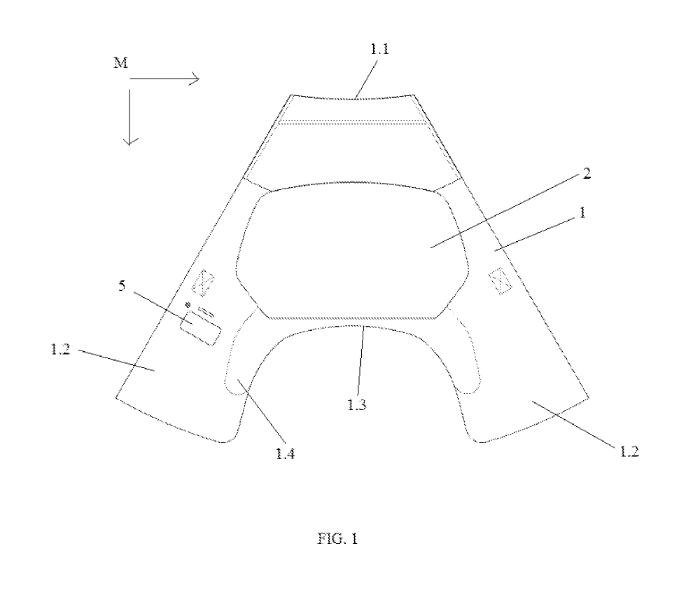

FIG. 2.: Side view of the ergonomic desk.

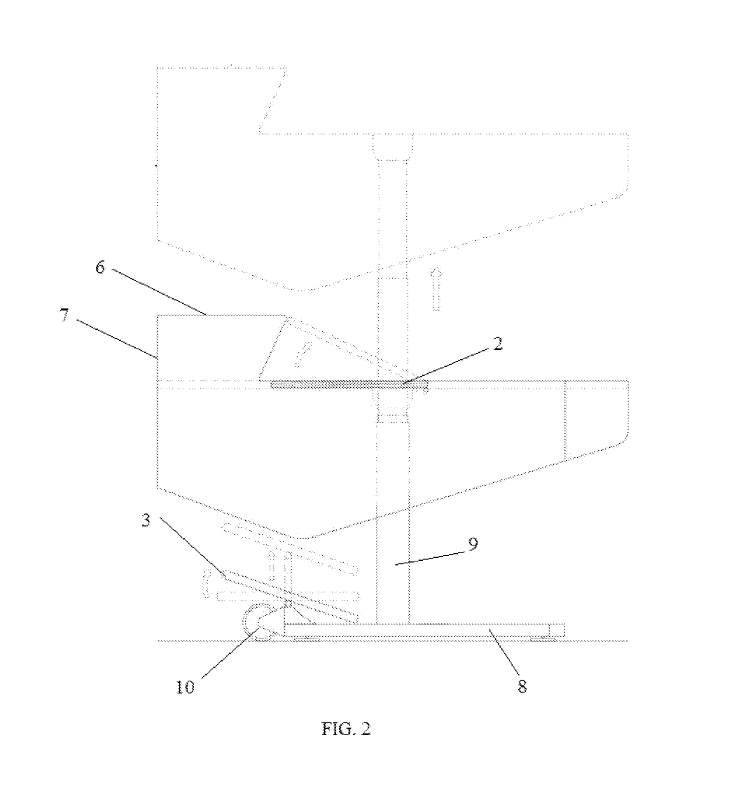

FIG. 3.: Mechanism for raising the height-adjustable plane.

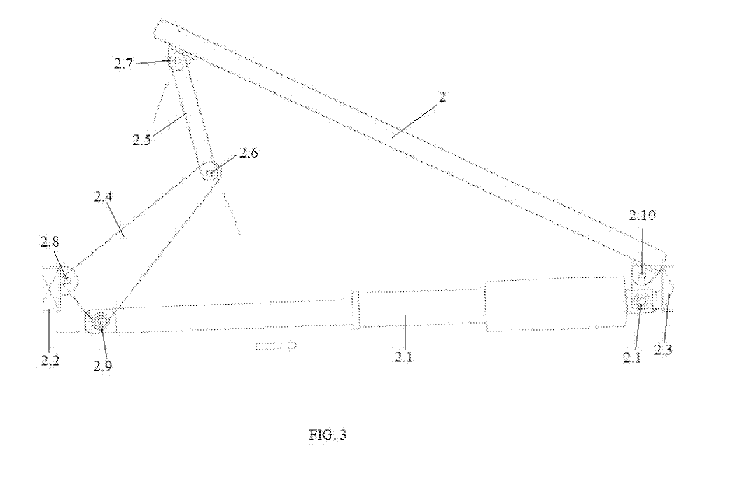

FIG. 4.: Overhead view of a grouped arrangement of six ergonomic desks.

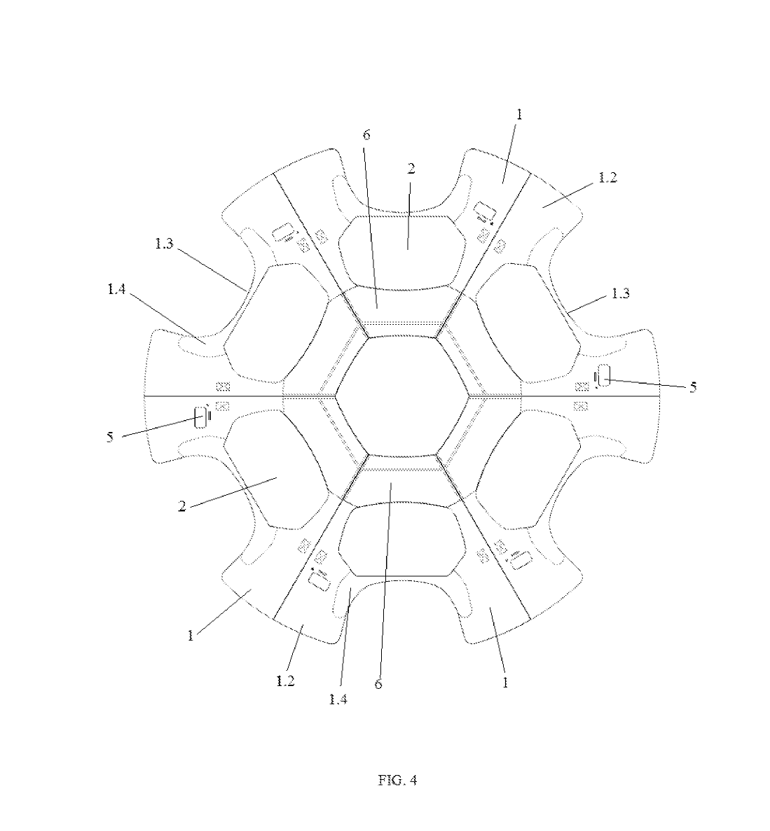

FIG. 5.: Overhead view of a linearly grouped arrangement of six ergonomic desks.

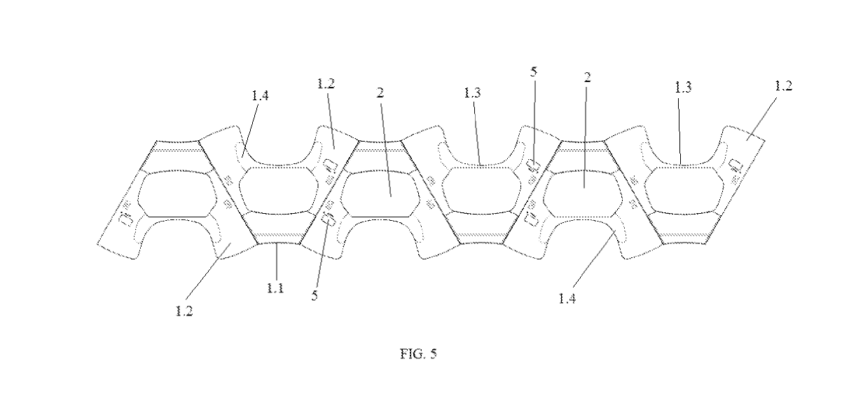

FIG. 6.: A geometric design of the curve ergonomically adapted to the user.

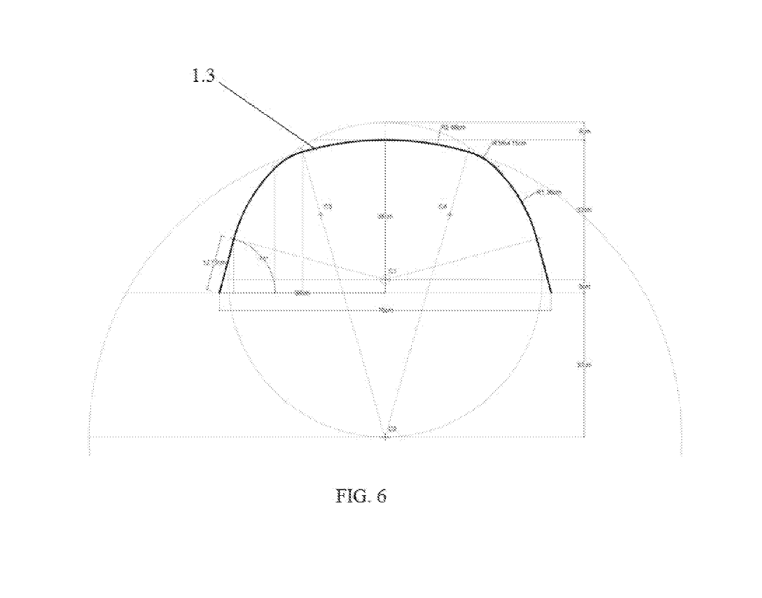

And in said figures, identical elements are marked with the same reference, amongst which the following can be distinguished:

(1).—upper desktop,
(1.1).—large-radius convex curve of the upper base of the desktop (1),
(1.2).—desk wings (M),
(1.3).—ergonomic curve adapted to the user,
(1.4).—cushioned manual support zone,
   (2).—height-adjustable plane,
(2.1).—telescopic linear actuator,
(2.2).—front mooring of the ergonomic desk,
(2.3).—rear mooring of the ergonomic desk,
(2.4).—turn transmission triangular strip,
(2.5).—transmission articulated rod,
(2.6).—strip rotating shaft with the articulated rod,
(2.7).—mooring with rotating shaft of the front part of the height-adjustable plane (2),
(2.8).—mooring with rotating shaft of the front attachment (2.2) of the ergonomic desk with the triangular strip (2.4),
(2.9).—rotating shaft of the triangular strip (2.4) with the front part of the linear actuator (2.1)
(2.10).—rotating shaft mooring of the rear part of the height-adjustable plane (2),
(2.11).—rotating shaft of the rear part of the linear actuator (2.1)
   (3).—footrest tray,
   (4).—height-adjustable motorised legs,
   (5).—electronic device with touch screen,
   (6).—raised tray located in the front part,
   (7).—rear support wall of the raised tray (6)
   (8).—flat support base of the ergonomic desk,
   (9).—front wheels of the flat support base (8),
   (10).—height-adjustable motorised legs

### DETAILED DESCRIPTION OF THE INVENTION

In today's new employment context, novel mobile devices have been integrated as working tools, such as laptop computers, “smartphones” and “tablets”, which have generated a change in the forms and postures for work and the needs in terms of available space for tasks to be completed. Four fundamental factors have in particular motivated this invention:
a) With the introduction of technology in the working environment, paper support is every time less used, reducing the work area needed per user.
b) The new mobile devices have led to the apparition of new work postures, which requires office desks to adjust to different heights/inclinations during the course of the day.
c) The time used working at the office is being reduced, and different users usually share workstations during the day.
d) Working procedures have evolved toward forms of collaborative organisation where various colleagues with multidisciplinary training in many cases complete a substantial part of their tasks in groups.

All that, together with the need to optimise the use of office space for cost-cutting purposes, leads to a need to be able to work on a flexible work support adapted in terms of its design to the user and to the division into their areas of use with reference to the activities to be engaged in there, and incorporated into a unit of space which allows for rapid collaboration with other colleagues.

The following are the indispensable and essential characteristics of the invention:
a) A top of triangular design of approximately 600, with a characteristic curve some 120 cm long around an opening of 76×38 cm where the worker is introduced and 180° surrounded by working surface, the depth of the surrounding surface varying between 35 and 50 cm, and the frontal end of said triangular form is designed to house the monitor on top, the user's legs extended underneath it and so making available a working area of approximately 7.530 mm² all within the user's reach, without requiring the user to move the chair and only extending the arms.
b) the central part of the top, approximately 80×50 cm, is separate from the remainder but flush at the same height with a joint of less than 3 mm, incorporating a lifting mechanism which tips it up to an angle of 25° so that said central surface of the top can be inclined, to adapt to different working postures when using mobile devices. Said mechanism occupies a depth of less than 5 cm to accommodate the position of the legs.
c) the individual desk is designed to be coupled in modular forms in a number of arrangements: with another 5 desks, to from a hexagonal unit of 6 posts, with other desks in alternating directions to form a longitudinal line, and any other layout allowing for group work at distances not exceeding 1000 mm from the nearest collaborator, for carrying out collaborative tasks.
d) A mobile footrest tray making it possible to complete the correct working posture for all parts of the body not retained in the seat, so adapting to different working postures.
e) Height-adjustable motorised legs allowing work to be done standing during part of the day, controlled by the user.
f) A raised tray at the front, overhanging the top and secured to it on the front outside wall.
g) A flat base fitted with wheels, to allow greater facility of movement in the office by a single user.

### DESCRIPTION OF THE PREFERRED EMBODIMENT

The invention proposed refers to a modular-design ergonomic desk to be combined in a group (M), comprising the following elements.
an upper desktop (1) of trapezoid design of approximate dimensions 158 mm base and 115 mm high, whose front end (1.1) is slightly convex curved and at right angles to the side faces (1.2) to form two wings approximately 400 mm wide, and between them a curve ergonomically adapted to the user (1.3) with a perimeter of approximately 120 mm and providing an opening approximately 380 mm deep and 700 mm wide at the part nearest the outside, allowing the user a working area of 7,530 mm over 1800 without having to move the chair and simply by extending the arms.
the curve ergonomically adapted to the user (1.3) consists of a central circular segment of 680 mm radius with two side sections each of circular segments of 360 mm radius and each ending in inclined straight segments of 127.5 mm, between whose ends the distance is 760 mm.
the desktop (1) has a height-adjustable plane (2) in the centre consisting of a trapezoid desktop with rounded corners and a maximum size of 480 mm high by 800 mm wide at the widest part.
Said height-adjustable plane (2), flush with the desktop (1) and with a joint of less than 3 mm, has a lifting device on its inside face so that it can be raised at the front, to find the right working angle for the user.
the device for raising the height-adjustable plane (2) comprises at least the following elements:
(2.1).—a telescopic or preferably a hydraulic linear actuator operated from the touch screen (5) of the electronic device,
(2.2).—front mooring of the ergonomic desk,
(2.3).—rear mooring of the ergonomic desk,
(2.4).—triangular strip for transmitting the rotation, attached at its three vertices to the articulated rod (2.5), to the telescopic linear actuator (0.1) and to the front mooring of the ergonomic desk (2.2) by the mooring with the rotating shaft (2.8.),
(2.5).—articulated rod for transmission of the thrust and rotation between the triangular strip (2.4) and the height-adjustable plane (2),
(2.6).—rotating shaft of the triangular strip (2.4) with the articulated rod (2.5),
(2.7).—mooring with rotating shaft of the front of the height-adjustable plane (2), with the articulated rod (2.5),
(2.8).—mooring with rotating shaft of the front mooring (2.2) of the ergonomic desk with the triangular strip (2.4),
(2.9).—rotating shaft of the triangular strip (2.4) with the front of the linear actuator (2.1),
(2.10).—mooring with the rotating shaft of the rear of the height-adjustable plane (2), and the ergonomic desk,
(2.11).—rotating shaft of the rear of the activator (2.1) on its mooring (2.3) of the ergonomic desk.

Operation of the device for raising the height-adjustable plane (2) is simple:

When the telescopic linear actuator (2.1) is operated from the screen (5), this begins to fold so that, thanks to its rear rotating shaft (2.6), the strip (2.4) thrusts the articulated rod (2.5) which pushes the height-adjustable plane (2) into the angular opening required.

The total height of the device doesn't exceed 60 mm, so that at any position it doesn't interfere in the space occupied by the legs of the user.

The area between the rear edge of the height-adjustable plane (2) and the rear edge of the desktop (1) is protected by a cushioned manual support area (1.4), highly recommended for daily work with electronic devices in the area of the height-adjustable plane (2).
footrest tray (3) which can also be operated from the electronic device (5) to adapt it to the user's preferences.
height-adjustable motorised legs (9). The ergonomic desk has height-adjustable motorised legs operated from the electronic device with touch-screen (5) making it possible to alter the ergonomic desk's working height to adapt it to the user's preferences and even to allow them to work while standing.
an electronic device with touch-screen (5). An intelligent electronic device, touch-screen-controlled, which enables the user to handle all the desk's utilities, i.e. to set the desktop (1) of the ergonomic desk to the perfect height, to set the height-adjustable plane (2) to the right angle, to place the footrest tray (3) in the right position and any other functions which may be added and controlled using the electronic device (5).
a raised tray (6) at the front, overhanging the desktop and secured to it on the external front face (7).
a flat base (8) carried on front wheels (10), allowing greater facility of movement in the office by a single user.

The most useful modular couplings include that comprising six ergonomic desks forming a hexagonal unit. This arrangement gives a working surface of 7.8 m2 in a closed square of 9.9 m2, representing a 38% reduction of the working area formed by traditional desks each of 1.60×1.80 (12.5 m2).

The individual ergonomic desk designed in this way offers a collaborating combination of several desks forming a hexagonal unit, so that the users of the various units have a shared working area with the user immediately alongside them, at a distance of less than 1,000 mm and so that, at a uniform height, the users can hold a simultaneous meeting, enclosed within a circle of 3,000 mm diameter.

The ergonomic desks can also be placed in a linear disposition, in alternating directions and in any the geometric imagination permits.

Following sufficient description of the nature of the invention and its practical implementation, it must be recorded that the specifications indicated above and represented in the attached drawings may be modified in detail provided that this does not alter their fundamental principles established in the previous paragraphs and summarised in the following claims.

1. Ergonomic desk and modular design for collaborative dispositions of the type comprising a height-adjustable desktop divided into three zones at various levels, characterised by consisting of the following:
a trapezoid upper desktop (1) of dimensions of approximately 158 mm at the base and a height of 115 mm, the front edge (1.1) of which is slightly convex curved and at right-angle to the side faces (1.2) which form two wings approximately 400 mm wide, and between them a curve ergonomically adapted to the user (1.3) of approximately 120 mm perimeter, creating an opening approximately 380 mm deep and 700 mm wide at the outside end, providing the user with a working area of 7,530 mm., over 1800.
the desktop (1) has a height-adjustable plane (2) in the centre consisting of a trapezoid desktop with rounded corners and a maximum size of 480 mm high by 800 mm wide at the widest part.
Said height-adjustable plane (2), flush with the desktop (1) and with a joint of less than 3 mm, has a lifting device on its inside face not exceeding 60 mm of height so that it can be raised at the front.
a tray footrest (3), operated by means of the electronic device (5).
height-adjustable motor-driven legs (9) controlled by the electronic device with touch-screen (5), making it possible to alter the ergonomic desk's working height.
an intelligent electronic device with touch-screen (5) which enables the user to handle all the desk's utilities and any other functions that can be added and controlled using the electronic device (5).
a raised tray (6) at the front, overhanging the desktop and secured to it on the external front side (7).
a flat base (8) carrying front wheels (10).

2. Ergonomic desk and modular design for collaborative dispositions of the type consisting of a height-adjustable desktop divided into three zones at various levels, as set forth in claim 1, characterised because the device for raising the height-adjustable plane (2), not exceeding 60 mm of height, comprises at least the following elements:
(2.1).—a hydraulic telescopic linear actuator operated from the touch screen (5) of the electronic device.
(2.2).—front mooring of the ergonomic desk,
(2.3).—rear mooring of the ergonomic desk,
(2.4).—a triangular strip for transmitting the rotation, attached at its three vertices to the articulated rod (2.5), to the telescopic linear actuator (0.1) and to the front mooring of the ergonomic desk (2.2) by the mooring with the rotating shaft (2.8.),
(2.5).—an articulated rod for transmission of the thrust and rotation between the triangular strip (2.4) and the height-adjustable plane (2),
(2.6).—a rotating shaft of the triangular strip (2.4) with the articulated rod (2.5),
(2.7).—a mooring with rotating shaft of the front of the height-adjustable plane (2), with the articulated rod (2.5),
(2.8).—a mooring with rotating shaft of the front mooring (2.2) of the ergonomic desk with the triangular strip (2.4),
(2.9).—a rotating shaft of the triangular strip (2.4) with the front of the linear actuator (2.1),
(2.10).—a mooring with the rotating shaft of the rear of the height-adjustable plane (2), and the ergonomic desk,
(2.11).—a rotating shaft of the rear of the activator (2.1) on its mooring (2.3) of the ergonomic desk.

3. Ergonomic desk and modular design for collaborative dispositions of the type consisting of a height-adjustable desktop divided into three zones at various levels, as set forth in claim 1, characterised because the curve, ergonomically adapted to the user (1.3), comprises a central circular segment of a 680 mm radius, with two lateral sections each made up circular segments of a radius of 360 mm and each ending in straight inclined segments of 127.5 mm, between the ends of which the distance is 760 mm.

4. Ergonomic desk and modular design for collaborative dispositions of the type consisting of a height-adjustable desktop divided into three zones at various levels, as set forth in claim 1 and where, in a modular coupling formed by six ergonomic desks to create a hexagonal unit, a working area of 7.8 m² is obtained, contained within a 9.9 m² square.
